(19) United States
(12) Patent Application Publication
(10) Pub. No.: US 2017/0295764 A1
(43) Pub. Date: Oct. 19, 2017

(54) FISHING LURE DEVICE AND METHOD

(71) Applicant: DENNIS PILLARD, JR., SILVER CREEK, NY (US)

(72) Inventor: DENNIS PILLARD, JR., SILVER CREEK, NY (US)

(21) Appl. No.: 15/487,252

(22) Filed: Apr. 13, 2017

Related U.S. Application Data
(60) Provisional application No. 62/322,154, filed on Apr. 13, 2016.

(51) Int. Cl. A01K 85/01; A01K 83/00; A01K 85/18; A01K 95/00

(52) U.S. Cl. CPC A01K 85/01; A01K 95/00; A01K 83/00; A01K 85/18

(57) ABSTRACT

A fishing lure device includes a body assembly, a replaceable-sponge, at least one line-eyelet configured for affixing a fishing line to the fishing lure device, at least one hook-eyelet useful for affixing a fishing-hook to the fishing lure device, and at least one fishing-hook removably affixable to the at least one hook-eyelet. The body assembly includes a first-body-section, a second-body-section, where the first-body-section and the second-body-section are removably coupleable to one another, with the first-body-section and the second-body-section including a cavity when coupled to one another. The replaceable-sponge is insertable into the cavity created by the first-body section and the second-body-section. The replaceable-sponge includes a bright color and a scent to further improve the attraction of fish. The first-body-section and the second-body-section include markings which resemble a baitfish.

### CROSS-REFERENCE TO RELATED APPLICATION

The present application is related to and claims priority to U.S. Provisional Patent Application No. 62/322,154 filed Apr. 13, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of fishing, trapping, and vermin destroying and more specifically relates to baits and fishing.

### 2. Description of Related Art

Fishing is the activity of attempting to catch fish. There are various methods for catching fish which can include gathering, spearing, netting, angling, or trapping. Fishing may include catching aquatic creatures aside from only fish. The most common form of fishing includes the use of a rod and reel which includes fishing line connected to a hook which contains bait. The bait may be in the form of smaller baitfish, worms, fishing lures, or other types of fish attractants.

A fishing lure is a type of artificial fishing bait which is designed to attract a fish's attention. Generally, lures use movement and/or look and color to attract fish. Many lures are equipped with one or more hooks that are used to catch the fish when they strike the lure. Most lures are attached to the end of a fishing line and have various styles of hooks attached to the body and are designed to elicit a strike. Many lures are commercially made but some can be hand-made such as fishing flies.

Most lures on the market today have an inferior design, are cheaply made, and do not attract a multitude of fish, but more often than not, come at an expensive price. Additionally, these lures are typically one color, cannot be updated to a different color, and take on water as soon as they're placed in the water. With these less-than-desirable design features, fishermen are typically left with catching only a small number of fish, which can be aggravating and discouraging. A suitable solution is desired.

U.S. Pat. No. 6,588,138 to Mitchell A. Gilbert relates to a baitfish lure. The described baitfish lure comprises a fishing lure consisting of an arched hollow body with an interior bait chamber. The interior chamber is divided into a buoyancy chamber and a bait chamber. A number of small openings are formed in the outer body to enable scent and bait particles to be broadcast from bait stored within the bait chamber as the lure is passed through the water. Access to the bait chamber is further provided by either a hinged cover or by a hinged connection formed in the lure body between the buoyancy chamber and the bait chamber. Access to the bait chamber is restricted while the lure is being passed through the water as a result of the water flow positioning either the cover or the hinged lure body over the opening to the bait chamber. When a liquid is used, a piece of felt or sponge is saturated with the liquid, and then placed within the chamber.

BRIEF SUMMARY OF THE INVENTION

In view of the foregoing disadvantages inherent in the known baits and fishing means art, the present disclosure provides a novel fishing lure device and method. The general purpose of the present disclosure, which will be described subsequently in greater detail, is to provide a fishing lure device and method to improve the likelihood of catching a variety of fish at an economical price.

A fishing lure device is disclosed herein. The fishing lure device preferably includes a body assembly, a replaceable-sponge, at least one line-eyelet configured for affixing a fishing line to the fishing lure device, at least one hook-eyelet useful for affixing a fishing-hook to the fishing lure device, and at least one fishing-hook removably affixable to the at least one hook-eyelet. Preferably the at least one fishing-hook includes one or more treble-hook(s). The at least one hook-eyelet is removable and replaceable, and the at least one hook-eyelet includes a figure-eight-shape in preferred embodiments.

The body assembly includes a first-body-section, a second-body-section, wherein the first-body-section and the second-body-section are removably coupleable to one another. The first-body-section and the second-body-section include a cavity when coupled to one another. The replaceable-sponge is insertable into the cavity created by the first-body-section and the second-body-section. Preferably, the replaceable-sponge includes a bright color to improve attraction of fish and is configured to include a scent to further improve the attraction of fish.

The first-body-section and the second-body-section are preferably removably affixable via a tongue-and-groove arrangement to provide a water-tight seal; the first-body-section and the second-body-section are each constructed from a plastic material for durability and longevity during use. Additionally, the first-body-section and the second-body-section include markings which resemble a baitfish, where the markings are painted upon each of the first-body-section and the second-body-section. The first-body-section and the second-body-section include a hollow-section to contain a weight, where the weight includes at least one ball-bearing such that the one or more ball-bearing(s) produces a sound to improve attraction of fish. The first-body-section includes a first-bill-half and the second-body-section further includes a second-bill-half to provide movement to the fishing lure device during use.

According to another embodiment, a method of using a fishing lure device is also disclosed herein. The method of using a fishing lure device includes a first step, providing a fishing lure device; a second step, opening the fishing lure device; a third step, placing a least one sound-producing ball-bearing within the fishing lure device; a fourth step, placing a replaceable-sponge within a cavity of the fishing lure device; a fifth step, affixing at least one fishing-hook to the fishing lure device; a sixth step, affixing the fishing lure device to a fishing line; a seventh step, commencing a fishing activity; an eighth step, terminating the fishing activity; a ninth step, opening the fishing lure device; a tenth step, removing the replaceable-sponge from the fishing lure device; an eleventh step, removing the at least one sound-producing ball-bearing from the fishing lure device; and a twelfth step, closing the fishing lure device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing lure device and method, constructed and operative according to the teachings of the present disclosure.

FIG. 1 is a perspective view of the fishing lure device during an ‘in-use’ condition, according to an embodiment of the disclosure.

FIG. 2 is a side view of the fishing lure device of FIG. 1, according to an embodiment of the present disclosure.

FIG. 3A is a rear perspective view of the fishing lure device of FIG. 1, according to an embodiment of the present disclosure.

FIG. 3B is a bottom perspective view of the fishing lure device of FIG. 1, according to an embodiment of the present disclosure.

FIG. 4 is a section view of the fishing lure device of FIG. 1, according to an embodiment of the present disclosure.

FIG. 5 is a flow diagram illustrating a method of use for a fishing lure device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to baits and fishing devices and more particularly to a fishing lure device and method as used to improve the ability of an angler to use a single fishing lure to attract a wide variety of fish with a single device.

Generally, the disclosed fishing lure device is an enhanced fishing lure that attracts fish with a colorful design and the scent of fish. This product may comprise a fishing lure, made of two injection-molded halves sealed together. The lure can have a tongue-and-groove seal around the perimeter to prevent water from seeping in when submerged. Installed in the belly of the lure can be a colorful sponge, which can be updated and swapped out for different colors at any time. In the water, the sponge can slowly release a fish essence, housed in a chamber next to the sponge or contained within the sponge, to attract larger fish. Further, the lure can include small figure-eight clips and ball-bearings that rattle and a colored tape or painted fish-marking design on the upper half of the lure for an improved appearance. The colorful tape can be swapped out for a different color if desired. The lure can be painted on the exterior and then sealed with a clear over-layer. Hooks can attach to the exterior of the lure to snag attracted fish.

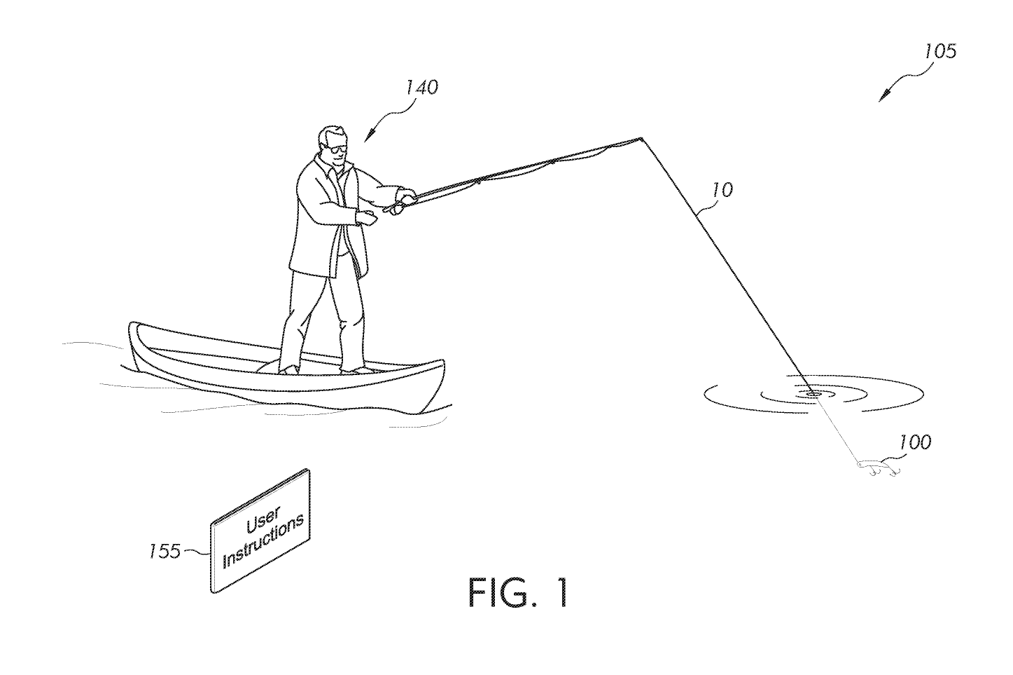

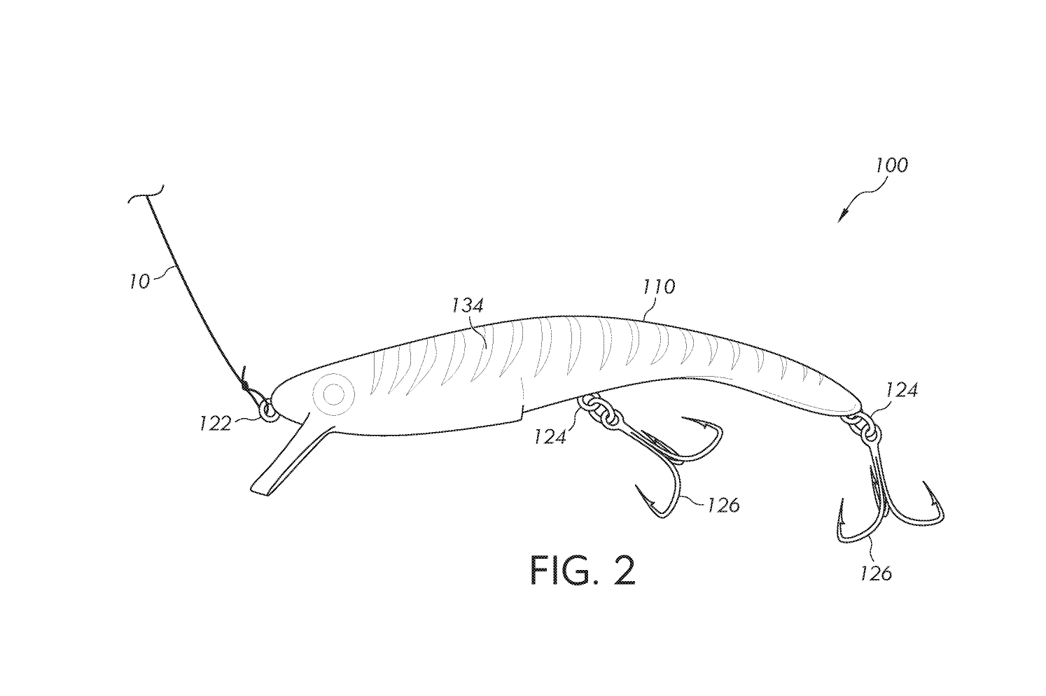

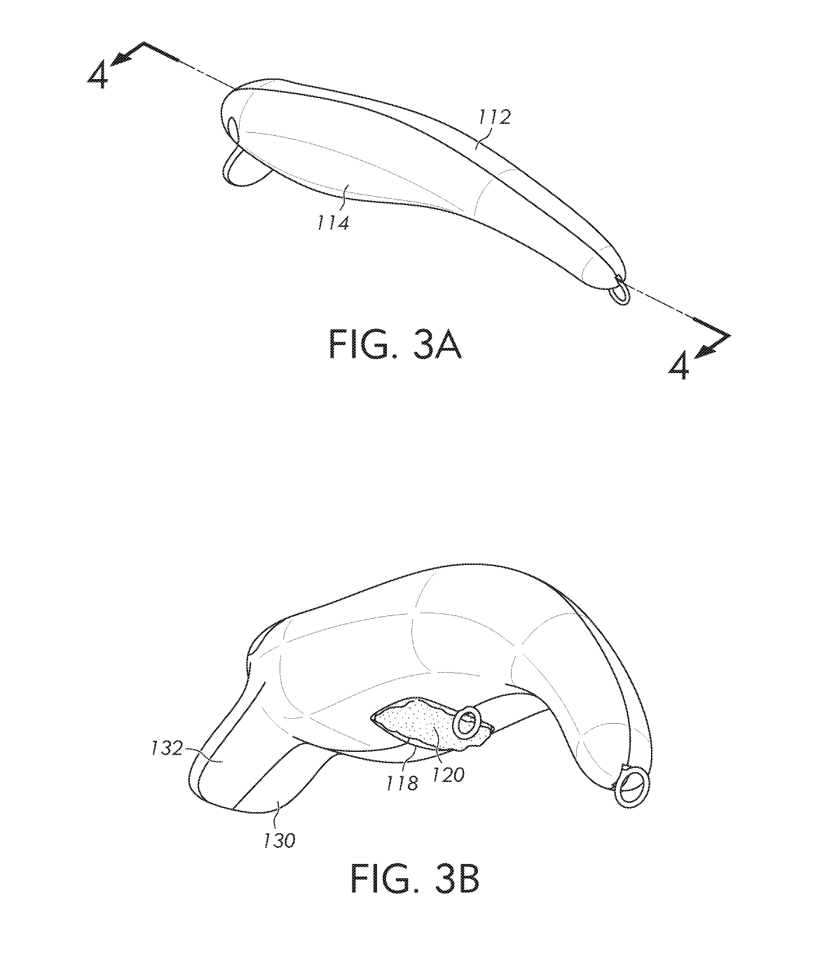

Referring now more specifically to the drawings by numerals of reference, there is shown in FIGS. 1-4, various views of a fishing lure device 100. FIG. 1 shows a fishing lure device 100 during an ‘in-use’ condition 150, according to an embodiment of the present disclosure. Here, the fishing lure device 100 may be beneficial for use by user 140 to attract and catch a wide variety of fish in an economical manner As illustrated, fishing lure device 100 may include body assembly 110, replaceable-sponge 120 (shown in FIG. 3B), at least one line-eyelet 122 (shown in FIG. 2) configured for affixing fishing line 10 (also shown in FIG. 2) to fishing lure device 100, and at least one hook-eyelet 124 (shown in FIG. 2) useful for affixing fishing-hook 126 (shown in FIG. 2) to fishing lure device 100.

According to one embodiment, the fishing lure device 100 may be arranged as a kit 105. In particular, fishing lure device 100 may further include a set of instructions 155. The instructions 155 may detail functional relationships in relation to the structure of fishing lure device 100 (such that fishing lure device 100 can be used, maintained, or the like, in a preferred manner).

FIG. 2 shows fishing lure device 100 of FIG. 1, according to an embodiment of the present disclosure. As above, fishing lure device 100 may include body assembly 110 including first-body-section 112, and second-body-section 114, where first-body-section 112 and second-body-section 114 may be removably coupleable to one another. First-body-section 112 and second-body-section 114 may include cavity 118 (with cavity shown in FIG. 3B) when coupled to one another (first-body section 112 and second-body-section 114 shown in FIG. 3A).

As shown, first-body-section 112 and second-body-section 114 may include markings 134 which may resemble a baitfish. In embodiments, markings 134 may be contained on a removable and replaceable tape. Additional embodiments may include markings 134 which may be painted upon each of first-body-section 112 and second-body-section 114.

Embodiments may include at least one fishing-hook 126 removably affixable to at least one hook-eyelet 124, where at least one fishing-hook 126 may include a treble-hook, in embodiments. Additional embodiments may include other types of fishing-hook(s) depending upon user preferences.

FIG. 3A is a rear perspective view of fishing lure device 100 of FIG. 1, according to an embodiment of the present disclosure. As previously stated, body assembly 110 may include first-body-section 112, second-body-section 114, where first-body-section 112 and second-body-section 114 are removably coupleable to one another, with first-body-section 112 and second-body-section 114 including a cavity when coupled to one another.

FIG. 3B is a bottom perspective view of fishing lure device 100 of FIG. 1, according to an embodiment of the present disclosure. Fishing lure device 100 may also include replaceable-sponge 120, where replaceable-sponge 120 may be removably insertable into cavity 118 created by first-body-section 112 and second-body-section 114. Replaceable-sponge 120 may include a bright color to improve attraction of fish, and replaceable-sponge 120 may include a scent to further improve attraction of fish, in embodiments.

First-body-section 112 may further include first-bill-half 130 and second-body-section 114 which may further include second-bill-half 132 to provide movement (e.g., up-and-down, side-to-side, combination thereof, etc.) to fishing lure device during use 100. First-body-section 112 and second-body-section 114 may be removably affixable via a tongue-and-groove arrangement to provide a water-tight seal during use. Fishing lure device 100 may be constructed from non-corrosive materials such that fishing lure device 100 may be usable in a salt-water environment without damage, where embodiments may include first-body-section 112 and second-body-section 114 each constructed from a plastic material for durability and longevity during use. Other embodiments may include other materials (e.g., wood, metallic materials, synthetics, etc.) or manufacturing methods.

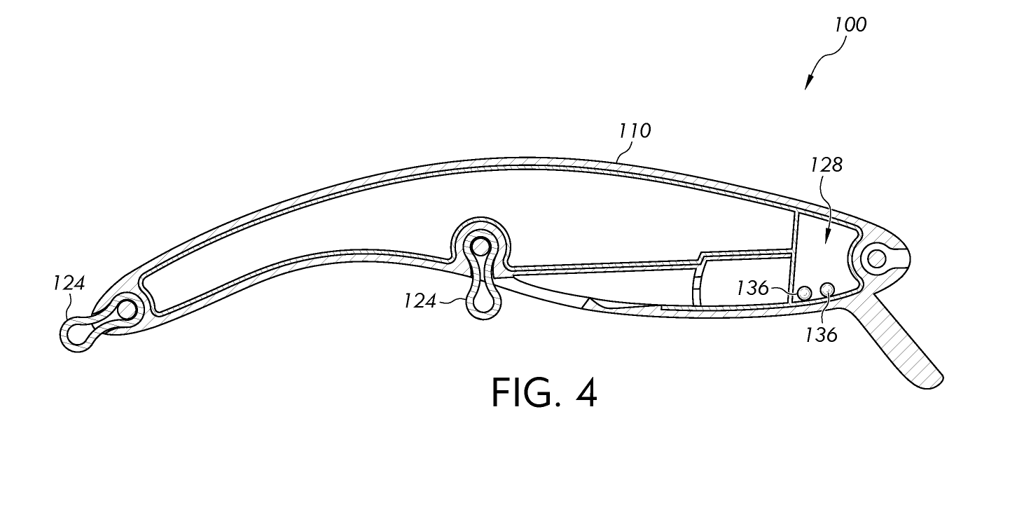

FIG. 4 is a section view of fishing lure device 100 of FIG. 1, according to an embodiment of the present disclosure. As shown, each of first-body-section 112 and second-body-section 114 of body assembly 110 may include hollow-section 128 to contain one or more weights 136. In embodiments, weight(s) 136 may include one or more ball-bearings such that ball-bearing(s) produces a sound to improve attraction of fish during use. Also shown in FIG. 4 is at least one hook-eyelet 124 which may be removable and replaceable, and at least one hook-eyelet 124 may include a figure-eight-shape, in some embodiments.

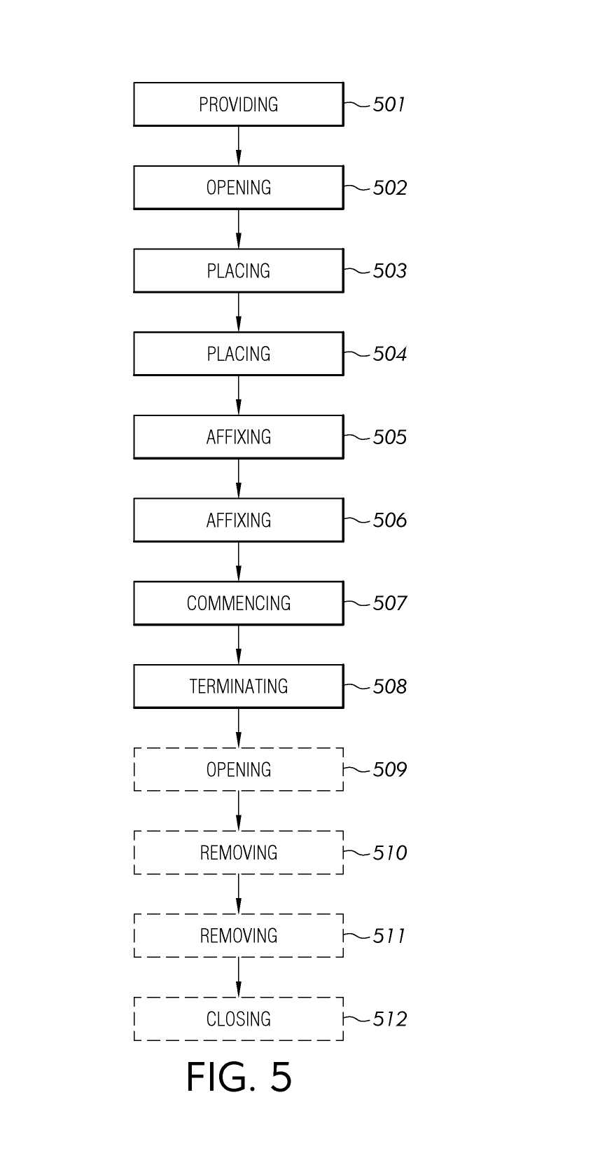

FIG. 5 is a flow diagram 550 illustrating a method of using 500 a fishing lure device 100, according to an embodiment of the present disclosure. In particular, the method for using 500 a fishing lure device 100 may include one or more components or features of the fishing lure device 100 as described above. As illustrated, the method for method of using 500 a fishing lure device 100 may include the steps of: step one 501, providing fishing lure device 100; step two 502, opening fishing lure device 100; step three 503, placing a least one sound-producing ball-bearing within fishing lure device 100; step four 504, placing replaceable-sponge 120 within cavity 118 of fishing lure device 100; step five 505, affixing at least one fishing-hook 126 to fishing lure device 100; step six 506, affixing fishing lure device 100 to fishing line 10; step seven 507, commencing a fishing activity; step eight 508, terminating the fishing activity; step nine 509, opening fishing lure device 100; step ten 510, removing replaceable-sponge 120 from fishing lure device 100; step eleven 511, removing at least one sound-producing ball-bearing from fishing lure device 100; and step twelve 512, closing fishing lure device 100.

It should be noted that step nine 509, step ten 510, step eleven 511, and step twelve 512 are an optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a fishing lure device (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fishing lure device, the device comprising:
a body assembly including a first-body-section, a second-body-section, where said first-body-section and said second-body-section are removably coupleable to one another, with said first-body-section and said second-body-section including a cavity when coupled to one another;
a replaceable-sponge, said replaceable-sponge removably insertable into said cavity;
at least one line-eyelet, said at least one line-eyelet configured for affixing a fishing line to said fishing lure device; and
at least one hook-eyelet, said at least one hook-eyelet useful for affixing a fishing-hook to said fishing lure device.

2. The fishing lure device of claim 1, wherein said fishing lure device further includes at least one fishing-hook removably affixable to said at least one hook-eyelet.

3. The fishing lure device of claim 2, wherein said at least one fishing-hook is a treble-hook.

4. The fishing lure device of claim 1, wherein said first-body-section further includes a first-bill-half and said second-body-section further includes a second-bill-half to provide movement to said fishing lure device during use.

5. The fishing lure device of claim 1, wherein said replaceable-sponge includes a bright color to improve attraction of fish.

6. The fishing lure device of claim 1, wherein said replaceable-sponge includes a scent to further improve attraction of fish.

7. The fishing lure device of claim 5, wherein each of said first-body-section and said second-body-section include markings which resemble a baitfish.

8. The fishing lure device of claim 7, wherein said markings are contained on a removable and replaceable tape.

9. The fishing lure device of claim 7, wherein said markings are painted upon each of said first-body-section and said second-body-section.

10. The fishing lure device of claim 1, wherein each of said first-body-section and said second-body-section include a hollow-section to contain a weight.

11. The fishing lure device of claim 10, wherein said weight includes one or more ball-bearings such that said one or more ball-bearings produces a sound to improve attraction of fish.

12. The fishing lure device of claim 1, wherein said first-body-section and said second-body-section are removably affixable via a tongue-and-groove arrangement to provide a water-tight seal.

13. The fishing lure device of claim 1, wherein said first-body-section and said second-body-section are each constructed from a plastic material for durability and longevity during use.

14. The fishing lure device of claim 1, wherein said at least one hook-eyelet is removable and replaceable.

15. The fishing lure device of claim 1, wherein said at least one hook-eyelet includes a figure-eight-shape.

16. The fishing lure device of claim 1, wherein said fishing lure device is constructed from non-corrosive materials such that said fishing lure device is usable in a salt-water environment.

17. A fishing lure device, the device comprising:
a body assembly including a first-body-section, a second-body-section, where said first-body-section and said second-body-section are removably coupleable to one another, with said first-body-section and said second-body-section including a cavity when coupled to one another;
a replaceable-sponge, said replaceable-sponge removably insertable into said cavity;
at least one line-eyelet, said at least one line-eyelet configured for affixing a fishing line to said fishing lure device;
at least one hook-eyelet, said at least one hook-eyelet useful for affixing a fishing-hook to said fishing lure device;
at least one fishing-hook removably affixable to said at least one hook-eyelet;
wherein said at least one fishing-hook is a treble-hook;
wherein said first-body-section further includes a first-bill-half and said second-body-section further includes a second-bill-half to provide movement to said fishing lure device during use;
wherein said replaceable-sponge includes a bright color to improve attraction of fish;
wherein said replaceable-sponge includes a scent to further improve attraction of fish;
wherein each of said first-body-section and said second-body-section include markings which resemble a baitfish;
wherein said markings are painted upon each of said first-body-section and said second-body-section;
wherein each of said first-body-section and said second-body-section include a hollow-section to contain a weight;
wherein said weight includes one ore more ball-bearings such that said one or more ball-bearing produce a sound to improve attraction of fish;
wherein said first-body-section and said second-body-section are removably affixable via a tongue-and-groove arrangement to provide a water-tight seal;
wherein said first-body-section and said second-body-section are each constructed from a plastic material for durability and longevity during use;
wherein said at least one hook-eyelet is removable and replaceable; and
wherein said at least one hook-eyelet includes a figure-eight-shape.

18. The fishing lure device of claim 17, further comprising set of instructions; and
wherein the fishing lure device is arranged as a kit.

19. A method of using a fishing lure device, the method comprising the steps of:
providing a fishing lure device;
opening said fishing lure device;
placing a least one sound-producing ball-bearing within said fishing lure device;
placing a replaceable-sponge within a cavity of said fishing lure device;
affixing at least one fishing-hook to said fishing lure device;
affixing said fishing lure device to a fishing line; and
terminating said fishing activity;

20. The method of claim 19, further comprising the steps of
opening said fishing lure device;
removing said replaceable-sponge from said fishing lure device;
removing said at least one sound-producing ball-bearing from said fishing lure device; and
closing said fishing lure device.
